(19) United States
(12) Patent Application Publication
(10) Pub. No.: US 2026/0228469 A1
(43) Pub. Date: Aug. 6, 2026

(54) ENABLING 5G CORE NETWORK SERVICES FOR AMBIENT INTERNET OF THINGS (AIOT) DEVICES

(71) Applicant: InterDigital Patent Holdings, Inc., Wilmington, DE (US)

(72) Inventors: Guanzhou Wang, Brossard (CA); Michael Starsinic, Newtown, PA (US); Mohamad Kenan Al-Hares, Canterbury (GB); Anuj Sethi, Ottawa (CA)

(73) Assignee: InterDigital Patent Holdings, Inc., Wilmington, DE (US)

(21) Appl. No.: 19/047,217

(22) Filed: Feb. 6, 2025

(51) Int. Cl. G06K 7/10; G16Y 10/75

(52) U.S. Cl. CPC G06K 7/10227; G16Y 10/75

(57) ABSTRACT

Methods for use in an ambient internet of things (AIoT) function (AIoTF) in a cellular core network, as well as an AIoTF node, are described. In one embodiment, the method comprises receiving, from an AIoT application function (AF), a first AIoT inventory request message including an AIoT device identifier. The AIoTF selects an AIoT reader based on AIoT device configuration information associated with the AIoT device identifier. The AIoTF transmits, to an AIoT device associated with the AIoT device identifier via the selected AIoT reader, a second AIoT inventory request message. Then, the AIoTF receives, from the AIoT device via the selected AIoT reader, an AIoT inventory response message. The AIoTF may select an AIoT reader further based on AIoT reader configuration information.

### BACKGROUND

In cellular communication systems, the Ambient IoT Function (AIoTF) is a new Network Function that has been introduced in the 5G core network (5GC) to enable AIoT services, such as Inventory, Command, and other AIoT services. An AIoTF receives and handles AIoT service requests from AIoT Application Function (AIoT AF) (for example, via NEF). For example, the AIoTF may locate the AIoT RAN node or BS Readers that can serve the target AIoT devices and forward service requests to the AIoT RAN node or BS Readers. The AIoTF may provide AIoT RAN nodes additional assistance information that may help the AIoT RAN node or BS Readers better perform AIoT service procedures. The AIoTF may provide AIoT service reports based on the AIoT device responses to the AIoT AF.

### SUMMARY

Methods for use in an ambient internet of things (AIoT) function (AIoTF) in a cellular core network, as well as an AIoTF node, are described. In one embodiment, the method comprises receiving, from an AIoT application function (AF), a first AIoT inventory request message including an AIoT device identifier. The AIoTF selects an AIoT reader based on AIoT device configuration information associated with the AIoT device identifier. The AIoTF transmits, to an AIoT device associated with the AIoT device identifier via the selected AIoT reader, a second AIoT inventory request message. Then, the AIoTF receives, from the AIoT device via the selected AIoT reader, an AIoT inventory response message.

In some embodiments, the AIoT device configuration information includes an association between the AIoT device and one or more AIoT readers.

In some embodiments, the AIoT device configuration information includes one or more of AIoT device radio frequency (RF) band information, AIoT device RF capabilities, AIoT device memory capacity, or information associated with a location of the AIoT device.

In some embodiments, the AIoTF receives, from the AIoT AF via a network exposure function (NEF), the AIoT device configuration information and the AIoT device identifier. Then, the AIoTF stores the AIoT device configuration information and AIoT device identifier for use in selecting the AIoT reader.

In some embodiments, the AIoTF selects an AIoT reader based on AIoT reader configuration information. The AIoT reader configuration information may include one or more of an AIoT reader network entity identifier to application layer identifier mapping, a serving area associated with an AIoT reader, or a frequency band associated with an AIoT reader.

In some embodiments, the AIoTF retrieves, from an AIoT data management function, the AIoT device configuration information or the AIoT reader configuration information.

In some embodiments, the AIoTF is configured to include assistance information in the second AIoT inventory request message to assist the selected AIoT reader.

In some embodiments, the AIoTF transmits, to the AIoT device associated with the AIoT device identifier via the selected AIoT reader, a third AIoT inventory request message, wherein a time between transmission of the second AIoT inventory request message and the third AIoT inventory request message is based on the AIoT device configuration information. The AIoT device configuration information may comprises energy information, and the energy information may be used to determine the time between the second AIoT inventory request message and third AIoT inventory request message.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram of an AIoT system architecture where an AIoTF in the 5GC has a direct interface to the AIoT RAN;

FIG. 3. is a block diagram of an AIoT system architecture where an AIoTF in the 5GC has an indirect interface via an AMF to the AIoT RAN;

FIG. 4A is a first portion of a call flow showing an example of an AIoT device information configuration service and an example of an AIoT device inventory service where an AIoTF selects an AIoT reader based on stored AIoT device configuration information; and

FIG. 4B is a second portion of a call flow showing an example of an AIoT device information configuration service and an example of an AIoT device inventory service where an AIoTF selects an AIoT reader based on stored AIoT device configuration information.

### DETAILED DESCRIPTION

The following acronyms are used herein:
5GC 5G Core Network
AF Application Function
AIoT Ambient IoT
AIoTF Ambient IoT Function
AMF Access and Mobility Management Function
BS Base Station
BS Reader Base Station Reader
DMF Data Management Function
IoT Internet of Things
NEF Network Exposure Function
NF Network Function
NRF Network Repository Function
OAM Operation Administration and Maintenance
RAN Radio Access Network
RF Radio Frequency
UE User Equipment

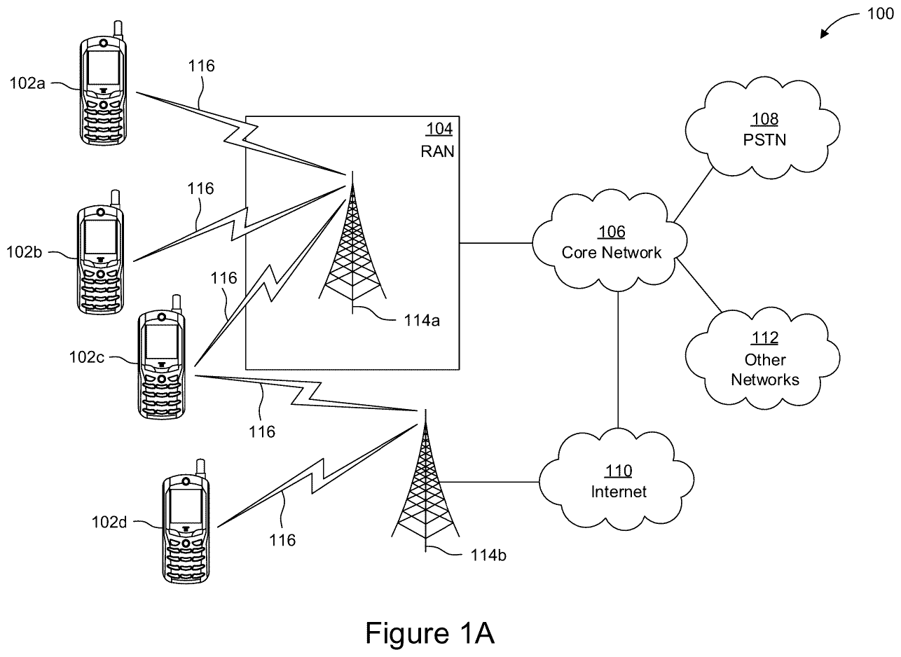

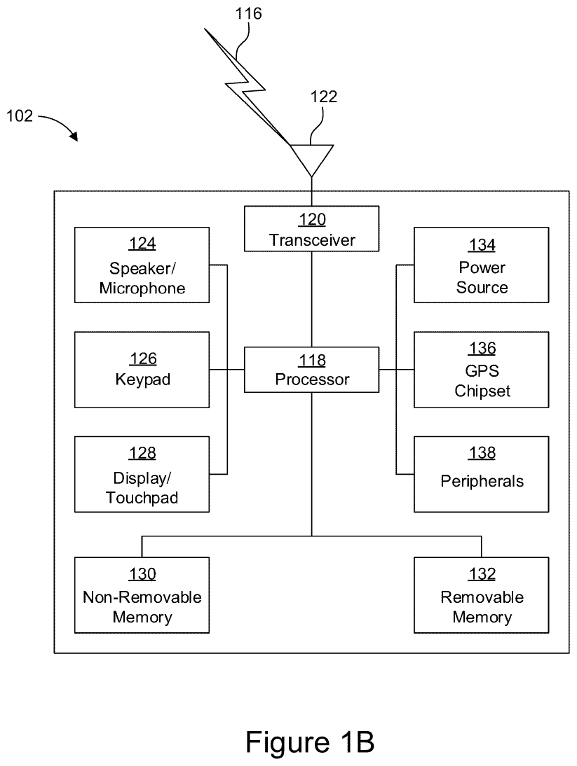

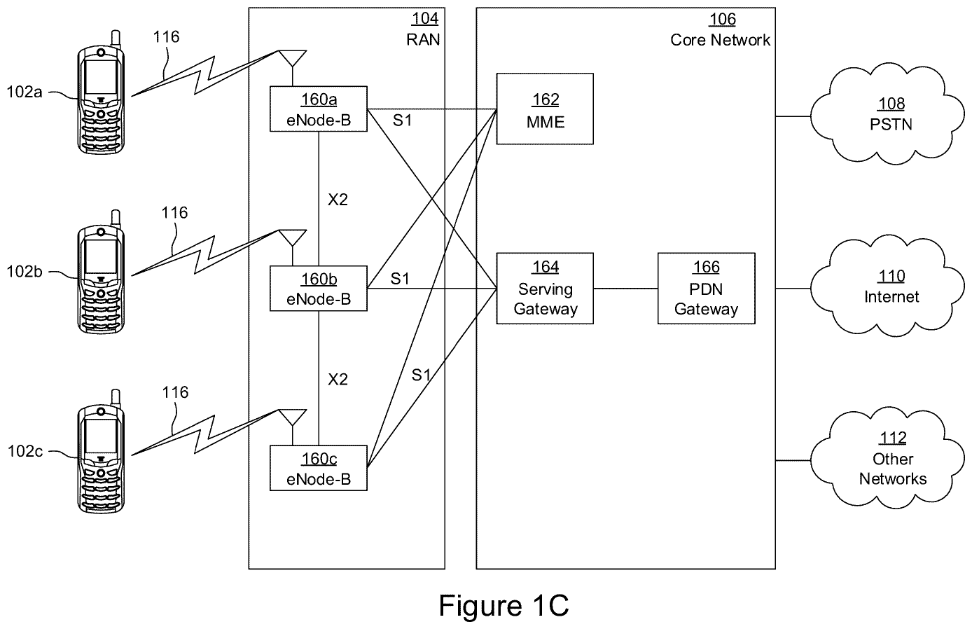

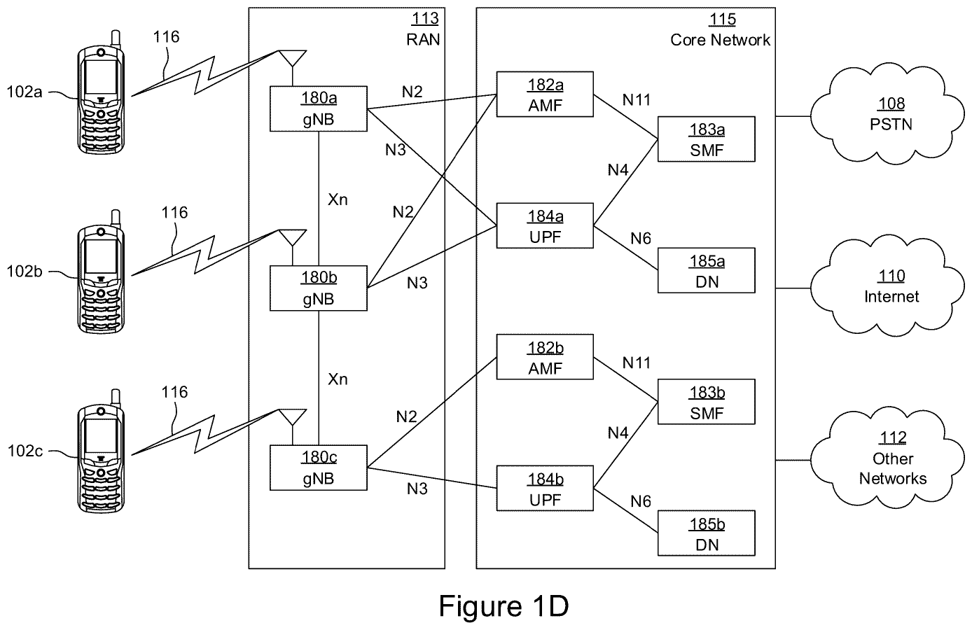

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

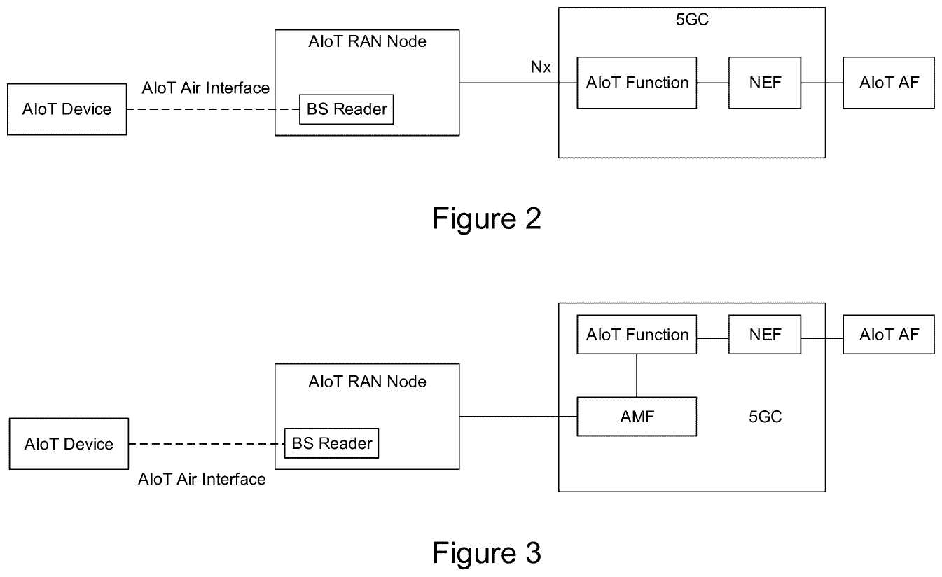

FIG. 2 and FIG. 3 shows block diagrams of network architectures of the 5GC with an AIoTF enabling AIoT services. In FIG. 2, AIoTF is located in a 5GC along with a NEF. An AIoT AF, located outside of the 5GC, interacts with the 5GC via the NEF. The AIoTF has a direct interface to one or more AIoT RAN Nodes, which include one or more BS readers. A BS reader may communicate with an AIoT device via the AIoT air interface. In FIG. 3, the architecture is similar but the AIoTF interacts with AIoT RAN Node indirectly, via an AMF.

The AIoTF is a 5GC Network Function that provides network services to other network functions via a service based interface that exposes its services to external entities, for example via an NEF. Because the AIoTF is dedicated to AIoT services, it may provide specialized services that cater to the needs of AIoT applications. Some basic services related to AIoT service operations are the Inventory Service and the Command Service. Other services may be needed by an AIoT AF or other 5GC NFs for AIoT device configuration, AIoT Reader configuration, AIoT device authentication or validation, exception event report, and the like. These potential services have not been explored in 3GPP for various AIoT use cases.

The AIoTF may provide a Device Information Configuration Service. The 5GC may expose a Device Information Configuration Service to an AIoT AF, either directly or via a NEF. The service producer may be the AIoTF or other NFs such as an AIoT Data Management Function (DMF). The Device Information Configuration Service enables the 5GC to configure necessary device information in related network functions (for example, the AIoTF and/or the AIoT DMF). An AIoT AF may invoke the 5GC's Device Information Configuration Service to provide the following device configuration.

An AIoT AF may invoke the 5GC's Device Information Configuration Service to provide the following AIoT device configuration: an AIoT Device-AIoT Reader association. This association information indicates one or multiple AIoT Readers (for example, identified by an AIoT Reader ID) that serves one or multiple AIoT devices (for example, identified by an AIoT device identifier). One AIoT device may be associated with one or multiple AIoT Readers; and one AIoT Reader may be associated with one of more AIoT devices. The AIoT Reader may be a BS Reader or a UE Reader and the Reader ID may be an application layer identifier. For example, the Reader ID may include information elements that identify the AIoT service provider name, or the name of the owner of the AIoT Reader, the name or code of the location where the AIoT Reader is deployed. The Reader ID may also be a network entity identifier such as Base Station ID.

An AIoT AF may obtain AIoT Device-AIoT Reader association information in several different ways. For example, the AIoT AF may be pre-configured with the AIoT Device-AIoT Reader association information by the AIoT service provider. For instance, the AIoT devices and AIoT Readers may be assets of the AIoT service provider and the AIoT service provider may have a business agreement with a 5G network operator to deploy those AIoT Readers in the network. In this scenario, the AIoT service provider controls how the AIoT Readers and AIoT devices are deployed/placed and may establish the AIoT Device-AIoT Reader association information to the AIoT AF. In other scenarios, the AIoT Readers are the assets of the network operator and the service provider may have a business agreement with the network operator to assign application-layer AIoT Reader IDs or obtain their network entity identifiers, and based on that the service provider can provide the AIoT Device-AIoT Reader association information to the AIoT AF.

In other embodiments, the AIoT AF obtains the AIoT Device-AIoT Reader association information through Inventory Service procedures. This is described below in connection with FIG. 3, steps 4 through 14. But briefly, the network report the AIoT Reader IDs from which an AIoT device's inventory responses are received to the AIoT AF. Based on these received inventory responses, the AIoT AF establishes the AIoT Device-AIoT Reader association information.

The AIoT Device-AIoT Reader association information may be stored in the AIoTF or the AIoT DMF or may be retrieved by the AIoTF from another NF. The AIoT Device-AIoT Reader association information enables the AIoTF to select one or multiple AIoT Readers that are associated with AIoT devices that the AIoTF receives AIoT service requests for, and enables the AIoTF to forward these received service requests to the selected AIoT Readers to be delivered to the AIoT devices that are the target of the AIoT service procedure.

An AIoT AF may invoke the 5GC's Device Information Configuration Service to provide the following AIoT device configuration: AIoT device frequency band and RF Capability. The AIoT device frequency band and/or RF capability information enables the AIoTF to select the AIoT Readers that support an AIoT device's frequency band and/or RF capability, or to instruct an AIoT Reader to use the same frequency band when communicating with the AIoT device (for example, to perform an AIoT paging procedure). The RF capability may include the RF technologies (i.e. backscattering) that the AIoT device supports for RF communication, the modulation/coding scheme that the device supports for RF communication, and other similar RF related information/parameters.

When the AIoTF receives an AIoT service request from an AIoT AF, the AIoTF can identify the AIoT device's working frequency band and/or RF capabilities based on stored AIoT device information, or AIoT device information retrieved from another NF. The AIoTF may provide the AIoT device frequency band and/or RF capability information as assistance information to one or more AIoT Readers along with the AIoT service request in order to facilitate the AIoT Readers'communication with the AIoT device.

In some embodiments, an AIoT device may support multiple frequency bands. In these embodiments, the AIoTF may instruct one or more AIoT Readers to use different frequency bands for different AIoT devices in the same location or adjacent areas. This may be beneficial for avoiding interference among AIoT devices when they are involved in AIoT service procedures at the same time.

An AIoT AF may invoke the 5GC's Device Information Configuration Service to provide the following AIoT device configuration: AIoT device memory capacity. The AIoT device memory capacity information enables the AIoTF to determine, or estimate, the AIoT device response message size (for example, a maximum message size) for certain AIoT service operation (for example, an AIoT Read command that requests the AIoT device to return data such as good information, sensor data, etc.). The estimated message size is important for the AIoT Reader to allocate radio channel resources for AIoT procedures carried over the AIoT air interface. Based on the AIoT device memory capacity, the AIoTF may provide the estimation of the response message size as part of assistance information to one or more AIoT Readers with the AIoT service request (for example, the Read command).

An AIoT AF may invoke the 5GC's Device Information Configuration Service to provide the following AIoT device configuration: AIoT device location. The AIoT device location information enables the AIoTF to locate the AIoT Readers that can communicate with the target AIoT devices and carry out the AIoT service requests. The precise AIoT Reader selection based on the device location information will typically increase the rate of service procedure success without unnecessarily involving AIoT Readers that do not serve the target AIoT device's location. The AIoT device location may be represented by a geographic point location defined by its coordinates (latitude, longitude, and altitude), or by an area (for example, circle, polygon, etc.) defined by multiple points, or by a civil address.

An AIoT AF may invoke the 5GC's Device Information Configuration Service to provide the following AIoT device configuration: disabled AIoT device list. When some AIoT devices are disabled or discarded by the owner or the AIoT service provider, the owner or the service provider may provide the list of the disabled/discarded AIoT devices to the 5GC. The disabled/discarded devices are supposed to turn off their RF transmission and not respond to AIoT service requests after being disabled/discarded. However, some of those devices may remain active for a variety of reasons. For example, the disable procedure may not be correctly carried out. This list of disabled/discarded devices may enable the AIoTF to filter out false responses from AIoT devices that are disabled/discarded and to generate exception reports to the AIoT AF.

When an AIoT AF invokes the Device Information Configuration Service, it should provide an AIoT device identifier as the key input together with some or all of the above discussed device configuration information. When the Device Information Configuration Service of the AIoTF is exposed via a NEF, the NEF will allocate the AIoTF and/or other NFs (for example, a centralized NF responsible for AIoT device information storage and management, such as the AIoT DMF) and invoke the Device Information Configuration Service provided by the AIoTF and/or other NFs. The allocation of AIoTF and/or other NFs may be based on the information elements included in the AIoT device identifier (for example, AIoT device owner information such as the network identifier, 3rd party identifier, service provider name,) or the AIoT device location information.

Upon the request of the AIoT AF to configure the above the AIoT device information, the AIoTF may store the information as part of the AIoT device context maintained in the AIoTF, or it may invoke another NF's service to store the device information in that NF (for example, a NF that provides data storage and management service for AIoT devices, such as the AIoT DMF).

In other embodiments, similar to the AIoT Device Information Configuration Service that provides AIoT device configuration information, an AIoT Reader Information Configuration Service may provide AIoT Reader configuration information.

The 5GC may expose an AIoT Reader Information Configuration services to an AIoT AF, either directly or via a NEF. The service producer may be an AIoTF or other NFs such as AIoT DMF, NRF, or OAM. The Reader Information Configuration Service enables the 5GC to configure necessary AIoT Reader information in related NFs (for example, the AIoTF). The AIoT Readers in the 5GC may be the assets of a third-party AIoT service provider that controls how the AIoT Readers are deployed. Alternatively, the AIoT Readers may be assets of the network operator, and the network operator may have a business agreement with the AIoT service providers and coordinate closely with them, thus the service providers may have the Reader deployment information. The AIoT service provider may use an AIoT AF to invoke the 5GC's Reader Information Configuration Service.

An AIoT AF may invoke 5GC's Reader Information Configuration Service to provide the following configuration: AIoT Reader's Network Entity ID-Application Layer Reader ID mapping information. An AIoT Reader (for example, a BS Reader), as a network entity, may have a network entity ID and address that's assigned by the network operator. On the other hand, the BS Reader may service one or multiple AIoT service providers and each AIoT service provider may assign an Application Layer Reader ID. The AIoT AF may use the Application Layer Reader ID when it requests AIoT services (for example, Inventory Service or Command) to the 5GC, and the 5GC may report the Application Layer Reader ID to the AIoT AF in AIoT service responses. This requires the 5GC to translate between the Reader's Network Entity ID and its Application Layer ID, and the mapping information will enable the 5GC to do so.

For example, when the 5GC receives an Inventory Request from the AIoT AF, and the Application Layer Reader ID (for example, as a last-known AIoT Reader that communicated with the device) is included in the request, the AIoTF may use locally stored mapping information or the AIoTF may retrieve the mapping information from other NFs to determine the Reader's Network Entity ID and address and forward the Inventory Request to the AIoT Reader.

For example, when an AIoT Reader receives an AIoT device response, the AIoT Reader may report the AIoT device response together with the device's Network Entity ID to the AIoTF, the AIoTF may use the mapping information to obtain the AIoT Reader's Application Layer ID and include the Application Layer ID in its service response sent to the AIoT AF.

An AIoT AF may invoke 5GC's Reader Information Configuration Service to provide the following configuration: AIoT Reader serving area. An AIoT Reader Serving Area may be defined in different ways. For example, the combination of the AIOT Reader's location (for example, point location defined by coordinates) and the AIoT Reader's coverage range (for example, in meters) may define the AIOT Reader's serving area. For example, a polygon defined by multiple point coordinates may define the AIoT Reader's serving area. The AIoT Reader's serving area can also be defined by a civil address. The configured AIoT Reader serving area will enable the AIoTF to select the AIoT Reader when handling AIoT service requests. For example, if the AIoT service request includes a target area, the AIoTF may select the BS Reader(s) whose serving area can cover the target area.

An AIoT AF may invoke 5GC's Reader Information Configuration Service to provide the following configuration: AIoT Reader frequency band. An AIoT Reader may support one or multiple frequency bands to communicate with AIoT devices. The AIoT Reader frequency band information enables the AIoTF to select an AIoT Reader (such as a BS Reader) that can communicate with the target AIoT device operating in a particular frequency band.

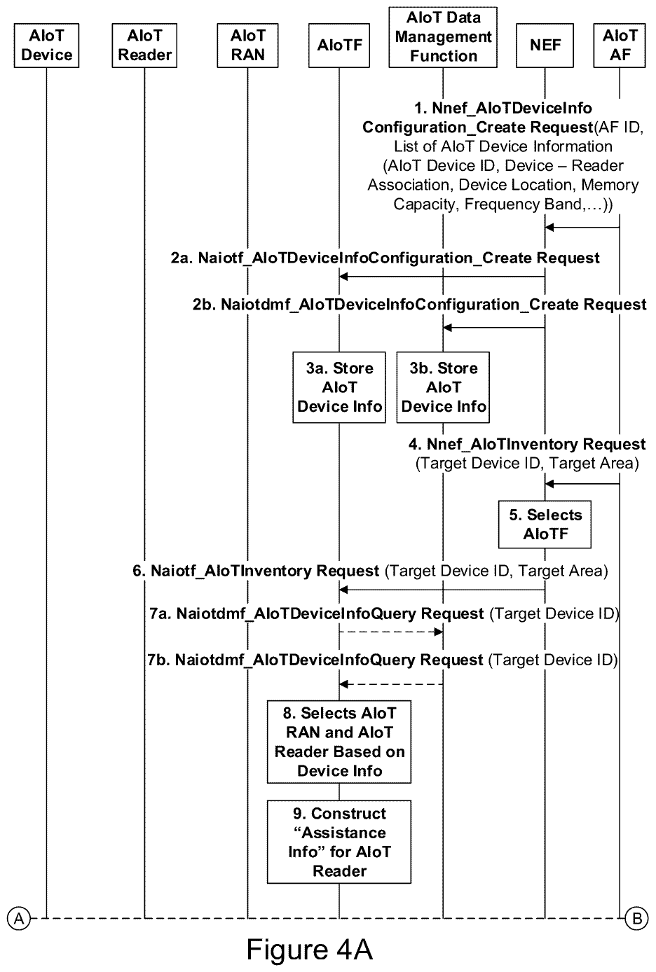

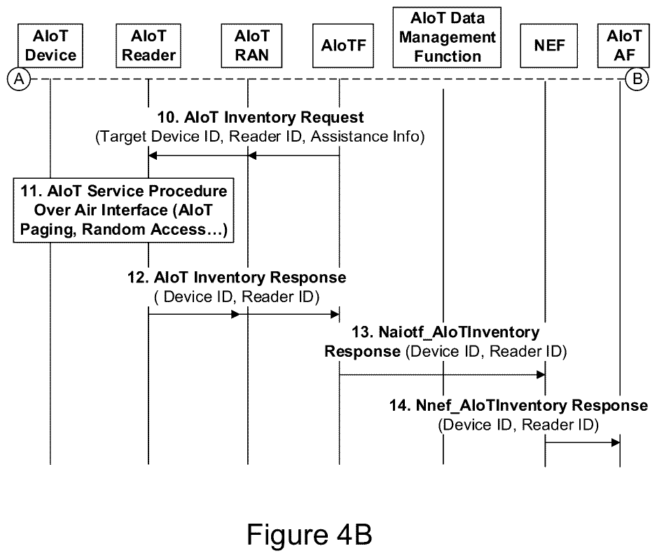

The AIoT AF may use the above described AIoT device and reader configuration information in various service procedures. FIGS. 4A and 4B is a signal flow diagram of an example procedure showing how configured AIoT device information may be used to support an AIoT Inventory procedure. Steps 1-3 describe the AIoT device information configuration procedure. Steps 4 through 14 describe the AIoT Inventory Service. These are two separate procedures and may be performed separately or together. In some scenarios, many instances of the AIoT information configuration procedure may be performed, at varying times. Similarly, the AIoT Inventory Service procedure may be performed at varying times, and AIoT device configuration information may be changed or updated between each instance of the AIoT Inventory Service procedure.

Referring to FIG. 4A, beginning at Step 1, the AIoT AF invokes the AIoT_DeviceInfoConfiguration service provided by the NEF. The AIoT AF transmits a request message, such as an Nnef_AIoTDeviceInfoConfiguration_Create Request, to the NEF. In the request, the AF provides a list of AIoT device information which may include an AIoT device identifier, and one or more of an AIoT device-Reader association information, an AIoT device location, an AIoT device memory capacity, and/or an AIoT frequency band. The various AIoT device information described above herein may be provided to the NEF.

In steps 2a/2b, the NEF locates an AIoTF and/or an AIoT DMF to handle the request of the AIoT AF. The selection of the AIoTF and/or an AIoT DMF may be based on the AF ID, or the device location, or the network configuration. The NEF may query an NRF to determine the AIoTF or AIoT DMF (not shown in FIG. 4A or 4B). Then, the NEF may invoke the AIoTF's (2a) or AIoT DMF's (2b) AIoT_DeviceInfoConfiguration service and send the device information input from the AIoT AF to the AIoTF in step 2a, and/or to the AIoT DMF in step 2b, in messages such as Naiotf_AIoTDeviceInfoConfiguration_Create Request from the NEF to the AIoTF and an Naiotdmf_AIoTDeviceInfoConfiguration_Create Request from the NEF to the AIoTF DMF.

In step 3a/3b, the AIoTF and/or the AIoT DMF stores the received device information. For example, the AIoTF may maintain a per-device context and store the received AIoT device information as part of the device context. The AIoT DMF may store the received AIoT device information in a centralized database.

As mentioned above, steps 1-3 describe the AIoT device information configuration procedure. While the description given above is shown as providing AIoT device deconfiguration information, the same procedure can be used for providing AIoT Reader configuration information.

Continuing, still with reference to FIG. 3, an AIoT Inventory procedure will be described. At step 4, the AIoT AF may initiate an AIoT Inventory request service by sending a request message, such as an Nnef_AIoTInventory Request, to the NEF. The AF may include in the request a target AIoT device identifier and a target area where the AIoT device might be located.

In step 5, the NEF selects an AIoTF that will handle the Inventory request. The selection of AIoTF may be based on at least the target area and the AIoTF's serving area, and/or network configuration. The NEF may query the NRF to determine the AIoTF (not shown in FIG. 3).

In step 6, the NEF forwards the Inventory Request to the selected AIoTF, in a message such as a Naiotf_AIoTInvetoryRequest. The target AIoT device identifier is included in the message.

In steps 7a/7b, ff the AIoTF does not have a device context corresponding to the target AIoT device identifier, it may query the AIoT DMF to retrieve the AIoT device information corresponding to the target AIoT device identifier. Otherwise, the AIoTF may use the AIoT device information stored in the AIoTF.

In step 8, the AIoTF may use the AIoT device information to select an AIoT RAN and one or more AIoT Readers (such as a BS Reader). For example, if the AIoT device information includes AIoT device - AioT Reader association information, the AIoTF may select the AIoT Reader ID(s) in the association information to locate the AIoT RAN and the AIoT Readers. If the Reader ID(s) are application layer identification, the AIoTF may need to translate the Reader ID(s) to its network entity ID(s) and then determine an AIoT RAN node and address. If the AIoT device - AioT Reader association information is not available, the AIoTF may not be able to directly select an AIoT Reader, but may select the AIoT RAN node instead (for example, based on the AIoT RAN serving area and the target area). It is noted here that the AIoTF selection of the AIoT Reader may be based on AIoT device configuration information associated with an AIoT device, it may be based on AIoT Reader configuration information associated with one or more AIoT Readers, or a combination of both.

In step 9, the AIoTF may construct assistance information for one or more selected AIoT Reader depending on the type of the AIoT service request. For example, if the service type is AIoT Inventory service, the assistance information may contain the AIoT device frequency band and AIoT device location. If the service type is AIoT Read service, the assistance information may additionally contain the AIoT device memory capacity. The assistance information may be constructed by the AIoTF based on the AIoT device configuration information that was received from the AIoT DMF.

In step 10, the AIoTF forwards the AIoT Inventory request to the selected AIoT RAN. If the AIoT Reader ID(s) is determined, the AIoTF also includes the AIoT Reader ID(s) in the request. If the assistance information is available, the assistance information is sent along with the Inventory request.

In step 11, the AIoT Reader carries out the air interface procedures such as AIoT Paging with the target AIoT device. The AIoT Reader may receive the device response to the paging. The AIoT Reader may use the assistance information provided in step 10 to facilitate communication with the AIoT device.

In step 12, the AIoT RAN/AIoT Reader forwards the AIoT device response to the AIoTF. The AIoT Reader ID (such as a BS Reader ID) that identifies the AIoT Reader that received the AIoT device response may also be included. The AIoTF may send a request to the AIoT DMF to store the AIoT Reader ID in the device information of the target AIoT device. The reason for storing the AIoT Reader ID in the device information is so that the AIoTF will be able to determine the AIoT Reader ID that was last used to successfully reach the AIoT device. The interaction between the AIoTF and AIoT DMF in this step is not shown.

Finally, in steps 13/14, the AIoTF sends the AIoT Inventory response to the AIoT AF (via NEF).

As described above in the context of the Inventory Service procedure shown with reference to FIGS. 4A and 4B, the AIoTF may receive stored device information from the AIoT DMF. This stored device information may be both AIoT device information and AIoT Reader information. In some embodiments, the stored device information may include information about the limitations of an AIoT device. For example, the stored device information may include information that indicates limits on how much data the AIoT device can send and receive in one operation. Thus, the AIoTF may use the stored device information to determine that multiple interactions with the AIoT device are required in order to accomplish a single request from the AIoT AF. For example, the AIoT AF may request to read a large amount of data from the AIoT device exceeding a maximum amount of data that the AIoT device can transmit in a single transaction, and the stored device information can be used by the AIoTF to determine that multiple read operations are needed in order to obtain the information that the AIoTF requested from the AIoT device. Alternatively, multiple operations may be required in a case where an AIoT device's energy storage capabilities are not sufficient to accomplish the AIoTF request in a single operation. When multiple operations are required, steps 10, 11, and 12 of FIG. 4B would be executed one time for each operation.

The stored device information may include information about the energy storage capabilities of the AIoT device, the energy cost of sending data to the AIoT device, and the energy cost of the AIoT device transmitting data to the AIoT Reader. Thus, the AIoTF may use the stored device information to determine that multiple interactions with the AIoT device are required in order to accomplish a single request from the AIoT AF. For example, the AIoT AF may request to read a large amount of data from the AIoT Device and the stored device information can be used by the AIoTF to determine that multiple different read operations are needed in order to obtain the information that the AIoTF requested from the AIoT Device. Multiple operations may be required because the AIoT Device's energy storage capabilities are not sufficient to accomplish the AIoTF request in a single operation. When multiple operations are required, steps 10, 11, and 12 of FIG. 4B would be executed one time for each operation.

The stored device information may include information about how fast the AIoT device is able to store energy (i.e. recharge). Thus, when the AIoTF determines to perform multiple operations with the AIoT device, the AIoTF may use the stored device information to determine how long the AIoTF should wait after completing a first operation before starting a second operation. For example, the AIoT AF may request to read a large amount of data from the AIoT device, and the stored device information can be used by the AIoTF to determine that multiple different read operations are needed in order to obtain the information that the AIoTF requested from the AIoT device. The AIoT AF may use the stored device information to determine how long to wait in between each read operation. When multiple operations are required, steps 10, 11, and 12 of FIG. 4B would be executed one time for each operation. The AIoTF may use the stored device information to determine how long to wait between the completion of step 12 and the repetition of step 10. The delay between step 12 and the second occurrence of step 10 allows time for the AIoT device to recharge.

The information about how fast the AIoT device is able to store energy (i.e. recharge) may be related to the time of day or other environmental factors. Thus, the AIoTF may use information about the environment to determine how long it takes the AIoT device to recharge. For example, during daylight hours an AIoT device that uses solar energy to recharge may recharge quicker whereas the same AIoT device may take a longer time to recharge at nighttime.

In some embodiments, AIoT Exception Event Notification services may be enabled by the 5GC. The 5GC may expose an AIoT Exception Event Notification service to an AIoT AF, either directly or via a NEF. The AIoT AF may subscribe to the 5GC for the following exception event notifications. In a first exception event notification, unexpected device responses are reported to the AIoT AF. When the 5GC (for example, the AIoTF) receives unexpected device responses, such as the previously mentioned device responses from a disabled AIoT devices, it may generate an exception event report and notify the AIoT AF. In the event report, the 5GC may include the event name, AIoT device ID, and/or time/location when/where the AIoT device response was received and the AIoT Reader ID that received the unexpected response. In a second exception event notification, reader out-of-service situations are reported to the AIoT AF. When one of multiple AIoT Readers are out of service, the 5GC may generate an exception event report and notify the AIoT AF. In the event report, the 5GC may include the event name, AIoT Reader IDs that are out of service, and/or serving areas of these AIoT Reader IDs.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in an ambient internet of things (AIoT) function (AIoTF) in a cellular core network, the method comprising:
receiving, from an AIoT application function a first AIoT inventory request message including an AIoT device identifier;
selecting an AIoT reader based on AIoT device configuration information associated with the AIoT device identifier;
transmitting, to an AIoT device associated with the AIoT device identifier via the selected AIoT reader, a second AIoT inventory request message; and
receiving, from the AIoT device via the selected AIoT reader, an AIoT inventory response message.

2. The method of claim 1, wherein the AIoT device configuration information includes an association between the AIoT device and one or more AIoT readers.

3. The method of claim 1, wherein the AIoT device configuration information includes one or more of AIoT device radio frequency (RF) band information, AIoT device RF capabilities, AIoT device memory capacity, or information associated with a location of the AIoT device.

4. The method of claim 1, further comprising:
receiving, from the AIoT AF via a network exposure function (NEF), the AIoT device configuration information and the AIoT device identifier; and
storing the AIoT device configuration information and AIoT device identifier for use in selecting the AIoT reader.

5. The method of claim 1, wherein selecting an AIoT reader is further based on AIoT reader configuration information.

6. The method of claim 5, wherein the AIoT reader configuration information includes one or more of an AIoT reader network entity identifier to application layer identifier mapping, a serving area associated with an AIoT reader, or a frequency band associated with an AIoT reader.

7. The method of claim 5, further comprising:
obtaining, from an AIoT data management function, the AIoT device configuration information or the AIoT reader configuration information.

8. The method of claim 1, wherein the AIoTF is configured to include assistance information in the second AIoT inventory request message to assist the selected AIoT reader.

9. The method of claim 1, further comprising:
transmitting, to the AIoT device associated with the AIoT device identifier via the selected AIoT reader, a third AIoT inventory request message, wherein a time between transmission of the second AIoT inventory request message and the third AIoT inventory request message is based on the AIoT device configuration information.

10. The method of claim 9, wherein the AIoT device configuration information comprises energy information, wherein the energy information is used to determine the time between the second AIoT inventory request message and third AIoT inventory request message.

11. An ambient internet of things (AIoT) function (AIoTF) node in a cellular core network, the AIoTF node comprising:
a receiver configured to receive, from an AIoT application function (AF), a first AIoT inventory request message including an AIoT device identifier;
a processor configured to select an AIoT reader based on AIoT device configuration information associated with the AIoT device identifier; and
a transmitter configured to transmit, to an AIoT device associated with the AIoT device identifier via the selected AIoT reader, a second AIoT inventory request message;
wherein the receiver is further configured to receive, from the AIoT device via the selected AIoT reader, an AIoT inventory response message.

12. The AIoTF node of claim 11, wherein the AIoT device configuration information includes an association between the AIoT device and one or more AIoT readers.

13. The AIoTF node of claim 11, wherein the AIoT device configuration information includes one or more of AIoT device radio frequency (RF) band information, AIoT device RF capabilities, AIoT device memory capacity, or information associated with a location of the AIoT device.

14. The AIoTF node of claim 11, wherein the receiver is further configured to receive, from the AIoT AF via a network exposure function (NEF), the AIoT device configuration information and the AIoT device identifier further comprising:
a memory configure to store the AIoT device configuration information and AIoT device identifier for use in selecting the AIoT reader.

15. The AIoTF node of claim 11, wherein the processor is configured to select an AIoT reader further based on AIoT reader configuration information.

16. The AIoTF node of claim 15, wherein the AIoT reader configuration information includes one or more of an AIoT reader network entity identifier to application layer identifier mapping, a serving area associated with an AIoT reader, or a frequency band associated with an AIoT reader.

17. The AIoTF node of claim 15, wherein the processor is further configured to obtain, from an AIoT data management function, the AIoT device configuration information or the AIoT reader configuration information.

18. The AIoTF node of claim 11, wherein the transmitter is configured to include assistance information in the second AIoT inventory request message to assist the selected AIoT reader.

19. The AIoTF node of claim 11, wherein the transmitter is further configured to transmit, to the AIoT device associated with the AIoT device identifier via the selected AIoT reader, a third AIoT inventory request message, wherein a time between transmission of the second AIoT inventory request message and the third AIoT inventory request message is based on the AIoT device configuration information.

20. The AIoTF node of claim 19, wherein the AIoT device configuration information comprises energy information, wherein the energy information is used to determine the time between the second AIoT inventory request message and the third AIoT inventory request message.
